(19) United States
(12) Patent Application Publication
(10) Pub. No.: US 2021/0010855 A1
(43) Pub. Date: Jan. 14, 2021

(54) PROPAGATION PATH ESTIMATION APPARATUS, METHOD, AND PROGRAM

(71) Applicant: NEC Corporation, Minato-ku, Tokyo (JP)

(72) Inventors: Reishi KONDO, Tokyo (JP); Tatsuya KOMATSU, Tokyo (JP)

(73) Assignee: NEC Corporation, Minato-ku, Tokyo (JP)

(21) Appl. No.: 17/040,266

(22) PCT Filed: May 11, 2018
(86) PCT No.: PCT/JP2018/018414

§ 371 Date: Sep. 22, 2020

(51) Int. Cl. G01H 3/04; G01H 17/00; G01H 3/12

(52) U.S. Cl. CPC G01H 3/04; G01H 3/12; G01H 17/00

(57) ABSTRACT

A memory is configured to store instructions and a processor is configured to execute the instructions, and the instructions comprise: propagation path estimation apparatus comprises calculating feature value from output signals from a plurality of sensors, and determining a propagation path corresponding to the feature value.

### TECHNICAL FIELD

The present invention relates to a propagation path estimation apparatus, a propagation path estimation method, and a program.

### BACKGROUND ART

There is known an estimation apparatus that estimates through which path an acoustic signal received at a receiving point has propagated in neighborhood. Non Patent Literature 1 describes an example of technology that estimates a direction of the transmission point of the acoustic signal received at the receiving point. According to the method described in this literature, utilizing a plurality of acoustic sensors, the direction of signal is estimated by the difference between times arriving at the plurality of sensors.

Patent Literature 1 discloses an analyzing method that analyzes acoustic propagation path correctly in a system between an acoustic source and a receiver side. This acoustic propagation analyzing method comprises a step of identifying all paths from the acoustic source to the receiver side, a step of measuring a propagation function from each path described as particle velocity vector to the receiver side, and a step of measuring operation load of each acoustic path. And this acoustic propagation analyzing method also comprises a step of describing a contribution of the particle velocity vector to the path by multiplying the operation load of each path to the propagation function to the receiver side, and a step of determining a dominant acoustic path described in particle velocity vector according to the contribution of each calculated path.

### CITATION LIST

### Patent Literature

[Patent Literature 1] Japanese Patent Kokai Publication No. JP2013-79953 A

### Non Patent Literature

[Non Patent Literature 1] Masanori Kato, Yuzo Senda and Reishi Kondo, “TDOA Estimation Based on Phase-Voting Cross Correlation and Circular Standard Deviation,” AASP-P1, EUSIPCO 2017 (2017 August)

### SUMMARY OF INVENTION

### Technical Problem

The following analysis is given by the present invention. A frequency response of the signal obtained at the receiving point may change significantly, depending on the propagation path. For example, when performing recording at a later stage of the propagation path, it is thought that the sound quality can be improved and unwanted sound can be removed by performing correction of frequency characteristics according to the propagation path. And for example, also in the case of detection in the later stages it is thought that detection performance can be improved by correcting frequency characteristics or switching over of detection scheme.

It is an object of the present invention to provide a propagation path estimation apparatus, propagation path estimation method and program that can contribute to enrich the estimating technology of propagated path of a signal.

### Solution to Problem

According to a first aspect of the invention, there is provided a propagation path estimation apparatus comprising: a feature value calculation part that calculates feature value from output signals from a plurality of the sensors, and a propagation path determination part that determines propagation path corresponding to the feature value.

According to a second aspect of the invention, there is provided a propagation path estimation method comprising: a step of calculating feature value from sensor output signals of a plurality of sensors, and a step of determining propagation path corresponding to the feature value. This method is combined to a particular apparatus, a propagation pass estimation apparatus that determines a propagation path based on the output signals from a plurality of sensors.

According to a third aspect of the invention, there is provided a program for causing a computer comprising: a process of calculating feature value from sensor output signals of a plurality of sensors, and a process of determining propagation path corresponding to the feature value. This program can be stored in a computer readable (non-transitory) storage apparatus. Therefore, this invention can be provided as a computer program product.

### Meritorious Effect of the Invention

According to the present invention, it is possible to estimate a path through which a signal has been transmitted.

### BRIEF DESCRIPTION OF THE DRAWINGS

FIG. 1 is a block diagram showing a configuration of a first exemplary embodiment of the present invention.

FIG. 2 is a diagram showing a relation with an acoustic source having in-air propagation in the first exemplary embodiment of the present invention.

FIG. 3 is a diagram showing a relation with an acoustic source having in solid substance propagation in the of first exemplary embodiment of the present invention.

FIG. 4 is a diagram explaining sound paths arriving at sensor 1 from an acoustic source having in-air propagation path in the first exemplary embodiment of the present invention.

FIG. 5 is a diagram explaining sound paths arriving at sensor 2 from an acoustic source having in-air propagation path in the first exemplary embodiment of the present invention.

FIG. 6 is a diagram explaining sound paths arriving at sensor 1 from an acoustic source having solid substance propagation path in the first exemplary embodiment of the present invention.

FIG. 7 is a diagram explaining sound paths arriving at sensor 2 from an acoustic source having solid substance propagation path in the first exemplary embodiment of the present invention.

FIG. 8 is a diagram explaining an example of another placement example of sensors in the first exemplary embodiment of the present invention.

FIG. 9 is a block diagram showing a configuration of a second exemplary embodiment of the present invention.

FIG. 10 is a diagram showing an operation of the second exemplary embodiment of the present invention.

FIG. 11 is a diagram showing a configuration of a computer making up a propagation path estimation apparatus according to the present invention.

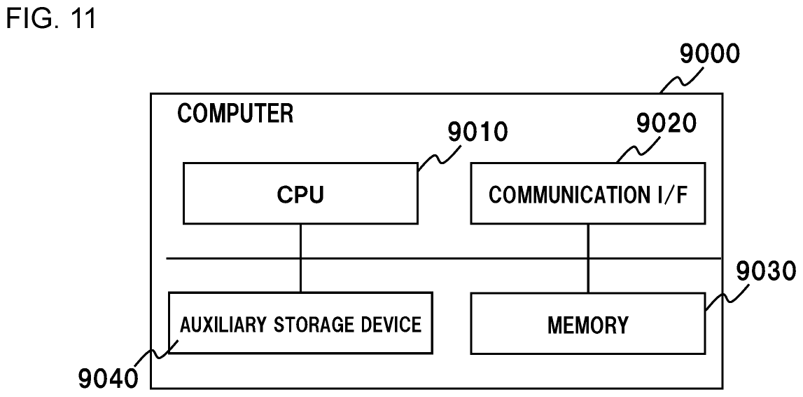

### DETAILED DESCRIPTION

### First Exemplary Embodiment

First, an outline of one mode of this invention will be described with reference to the drawings. Reference numbers attached to the drawings in this outline are for convenience as an example for facilitating understanding, and not intended to limit the present invention to the illustrated modes. And each connection line between blocks in the referenced drawings appearing in the following description includes both bi-directional and single-directional. A single-directional arrow describes main data flow schematically, which, however, does not exclude bi-directionality. There is a port or interface in each joint point of block diagram in the figures, but is not described in the figures.

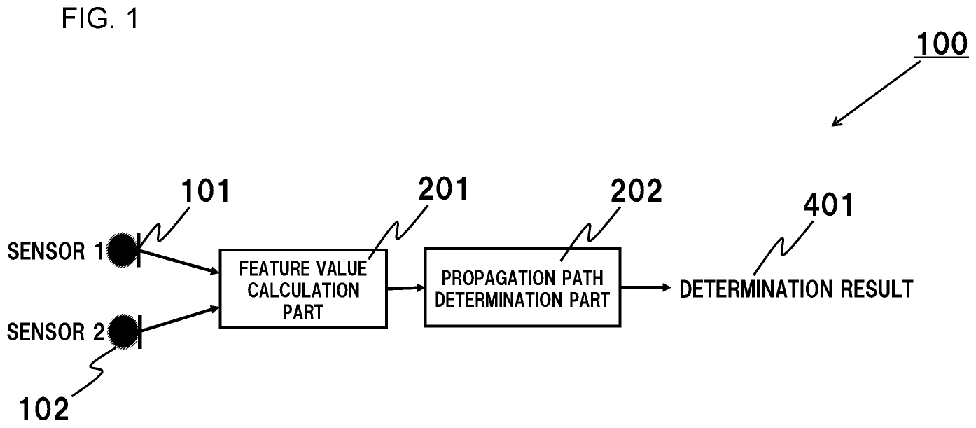

FIG. 1 is a block diagram showing a configuration of a first exemplary embodiment of the present invention. Referring to FIG. 1, in one exemplary embodiment, propagation path estimation apparatus 100 comprises a plurality of sensors 101 and 102 (hereafter, also described as sensor 1, sensor 2), feature value calculation part 201, and propagation path determination part 202.

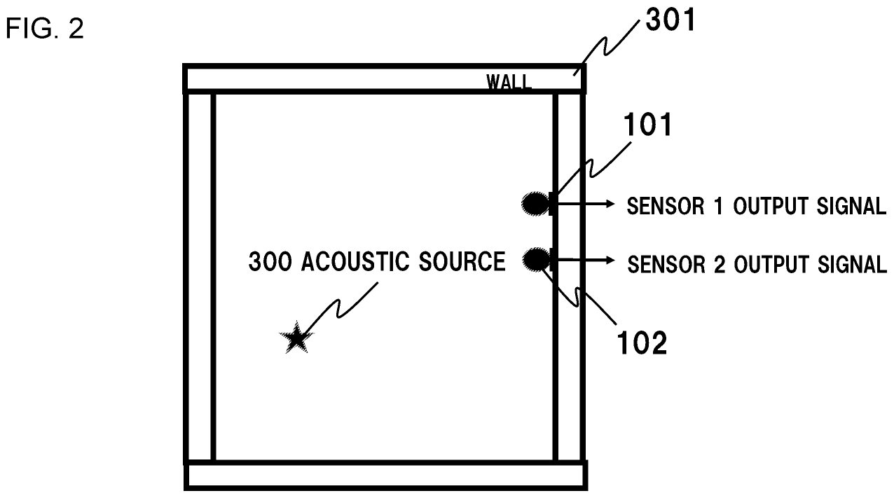

In general, each of these elements operates as follows. A plurality of sensors 101 and 102 are installed at a predetermined interval, and each sensor acquires information of received signal. As FIG. 2 shows an example of installing, in which sensors 101 and 102 are arranged along the wall. It is assumed that in this exemplary embodiment outputs of sensors 101 and 102 can be treated as time series signals of digital quantity.

The feature value calculation part 201 calculates, from the signals received by the sensors 101 and 102, a feature value that represents a spatial path required for arrival and transmission of the signal, at a predetermined time cycle period.

The propagation path determination part 202 determines whether the signal input to sensor 101 and sensor 102 has propagated in-air or in the solid substance according to the feature value and outputs determination result 401.

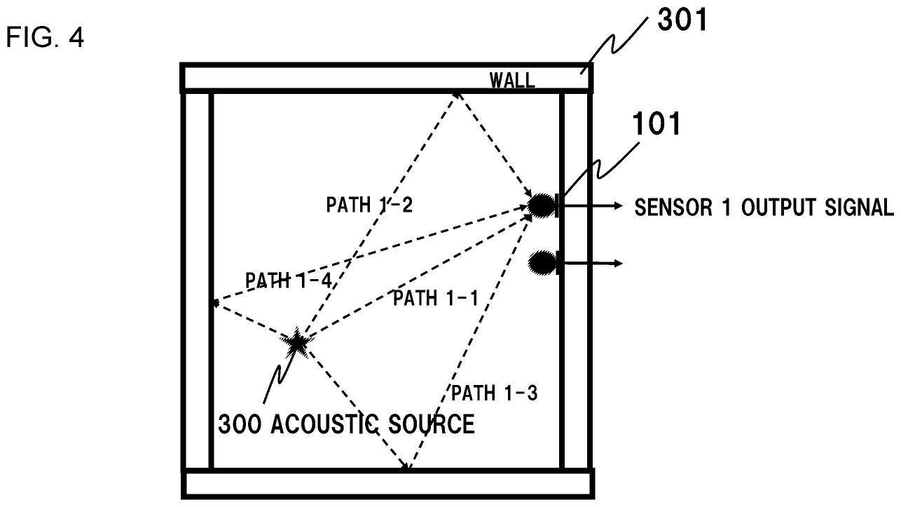

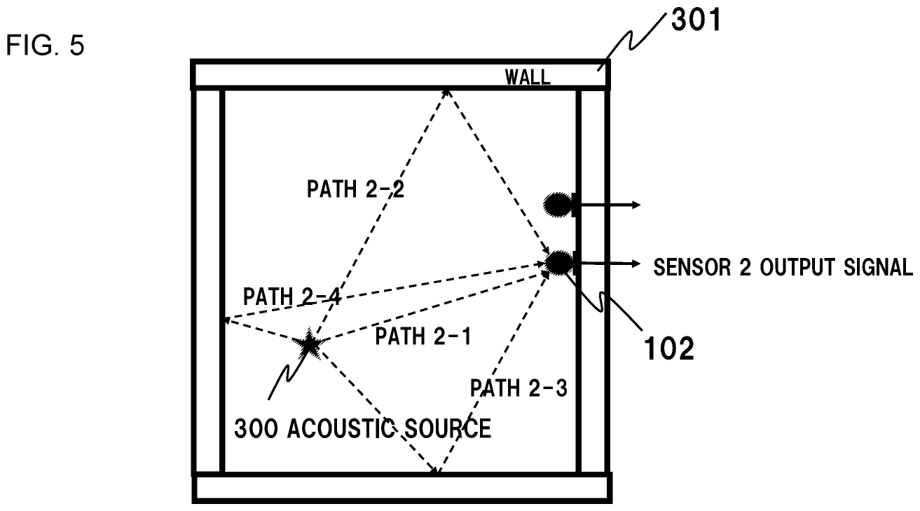

Next, overall operation of the present exemplary embodiment will be described with reference to FIG. 1-8. First, two events that are targets of identification by the propagation path estimation apparatus of this exemplary embodiment, such as sound propagating in-air and sound propagating in solid substance, are described with reference to FIG. 2-7. Sound propagating in-air is defined as air is interposed between the acoustic source 300 and sensor 101 and sensor 102, as shown in FIG. 2. In this case, as shown in FIG. 4, there are multiple acoustic propagation paths, as reflected acoustic path 1-2, acoustic path 1-3, acoustic path 1-4 other than acoustic path 1-1 reaching the sensor 1 101 directly from the acoustic source 300. In this case, at sensor 1 as a receiving point, the sounds along these acoustic paths are observed in a mixed form customarily. Similarly, acoustic paths from acoustic source 300 to sensor 2 102 are observed.

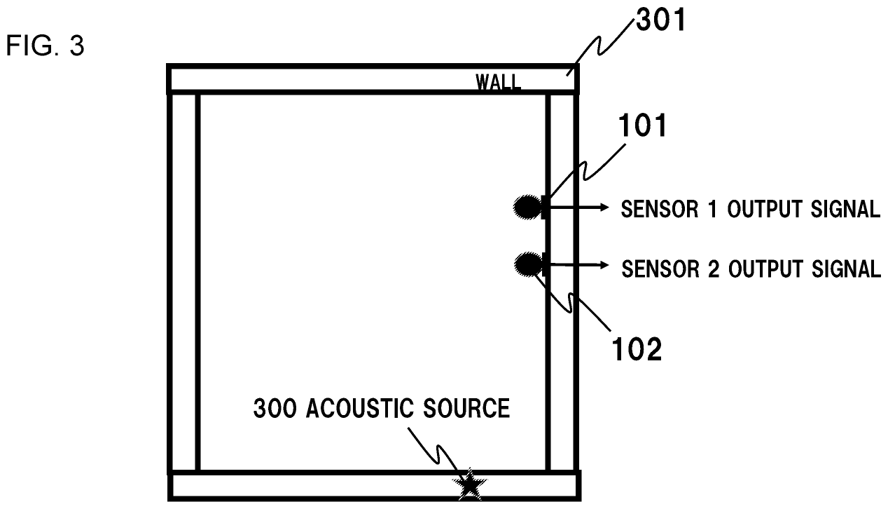

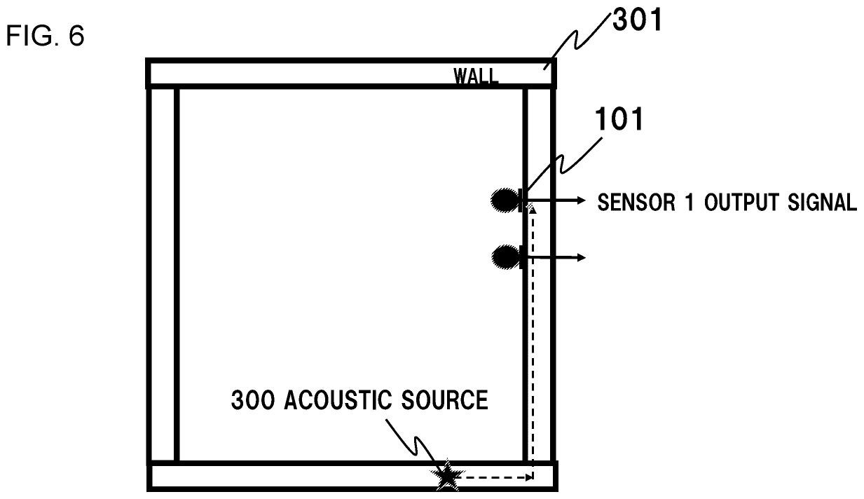

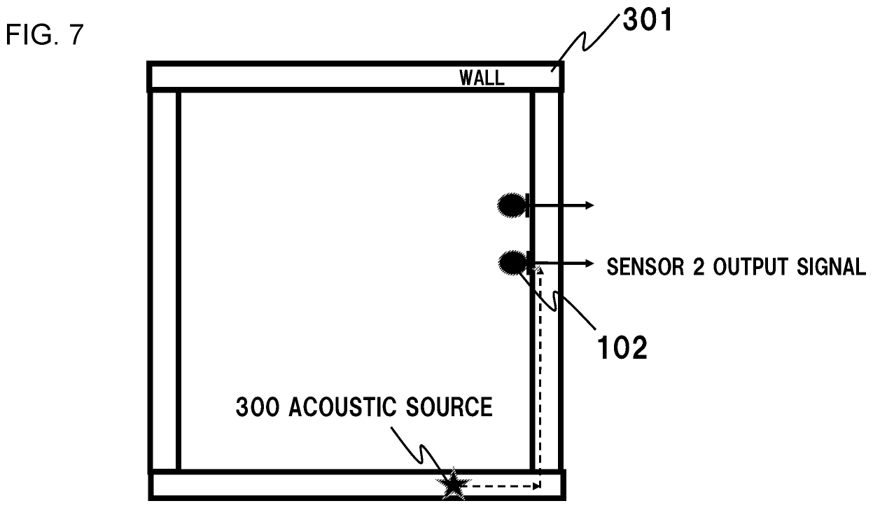

In contrast, as to the sound propagated in solid substance, that is a wall in the case shown in FIG. 3, acoustic source 300 is installed on the solid substance. In this case, there is only direct acoustic path reaching sensor 1 101 from acoustic source 300, and there is no reflected sound as shown in FIG. 6. Similarly, as shown in FIG. 7, acoustic path reaching sensor 2 102 from acoustic source 300 is observed.

Here, a microphone is used for sensor 1 101 and sensor 2 102 respectively. A feature value calculation part 201 calculates cross spectrum of the input signals from sensor 101 and sensor 102 sequentially. That is, cross-spectrum W(f) at a given time point can be calculated as W(f)=X1(f) X2*(f) wherein assumed are: the signal series x1(t) of sensor 101, the signal series x2(t) of sensor 102, Fourier transform of x1(t) being X1(f), Fourier transform of x2(t) being X2(f), and the complex conjugate of X2(f) being X2*(f).

This cross-spectrum itself or the shape of cross-spectrum cut out by a filter with appropriate shape describes the inverse of the similarity, a propagation path from acoustic source 300 to sensor 1 101 with a path to sensor 2 102, that is the difference between them.

In calculating the cross-spectrum, norm-normalizing can remove the dependence on the loudness of sound.

A cross-correlation function between the plurality of sensors 101 and 102 can be obtained by inverse Fourier transforming this difference. Here, this cross-correlation function is output as feature value.

Next, the operation of the propagation path determination part 202 will be described. When the cross-correlation function that is generated by feature value calculation part 201 has a single peak, it is clear that only a time-delay relationship between a plurality of sensors 101, 102. In this case, since there is no influence due to reflected sound, the propagation path determination part 202 determines that the sound has propagated in solid substance and outputs a determination result 401.

On the other hand, when the cross-correlation function generated by feature value calculation part 201 has more than one peak, there is influence due to reflected sound since there is a relationship other than the time-delay between the plurality of sensors 101 and 102, the propagation path determination part 202 determines that the sound has propagated in air, and outputs a determination result 401.

Although description has been made assuming that the number of sensors described here is two, the number can be set to three or more, and decisions can be made between each of them, and decisions can be made by majority, by taking logical sum, or logical product, thereby enabling increase in the estimation accuracy.

Also, the propagation path determination part 202 can operate only when the received signal has power at a certain level or more. This can reduce errors that occur under a condition of low power signals and thus under a low S/N ratio condition.

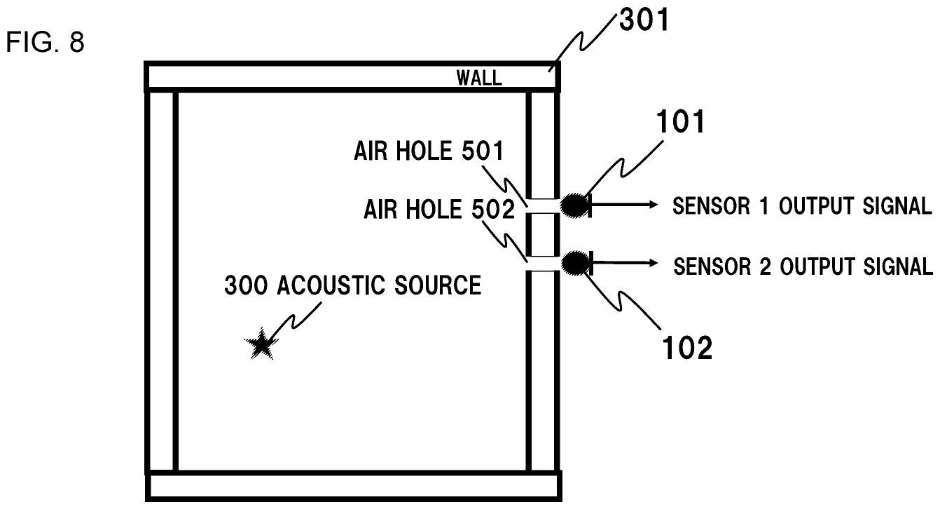

Although a plurality of sensors is installed exposed on the wall 301 as solid substance in FIG. 2, a plurality of sensors can be installed behind the wall 301 as shown in FIG. 8 or embedded in the wall 301. In this case, it is preferred that air holes 501 and 502 are provided for the proper operation of the sensors, respectively.

Although a microphone(s) as the plurality of sensors 101 and 102 is (are) used in this exemplary embodiment, a scope of application of the present invention need not be limited to acoustic signals in the audible range, supersonic microphones and infrasonic sensors or the like can be used.

Although an acoustic source 300 is installed on the wall 301 in FIG. 3, it is possible that the sound propagated in air from the acoustic source 300 could vibrate the wall 301 and thus propagate in (or through) the wall 301. For example, the following cases may occur in an apartment complex where the sounds emitted in a neighboring house or in a house on different floor(s) (living noise) can be heard. For example, when all the windows are open, the noise is transmitted through the air, but even if the windows are closed, the noise is transmitted in a solid substance such as a building frame body of the apartment building. The above propagations in-air and the in the wall correspond to the case of the household noises in a housing complex, and it is easy to understand that the frequency characteristics are different in each case.

Above described are, as the typical propagation path, in-air and in solid substance, but other substances can be used as well, provided that the path in air is a typical path with reflections and the path in solid substance is a typical path without reflections. For example, air can be substituted by a gas such as nitrogen, liquid such as water or the like. And solid substance can be substituted by a sufficiently viscous gel like object or the like.

Next, the effect of the present exemplary embodiment will be described. According to the present exemplary embodiment, a plurality of sensors are used to estimate the path(s) to be transmitted of the signal, so that the information only at the receiving point is needed for estimation of the propagation path(s), and the information at the transmitting side or transmission path are not needed. In other words, this exemplary embodiment allows for calculating in the standard operation without calibration in a special space, therefore resulting in a merit that installing cost can be reduced.

### Second Exemplary Embodiment

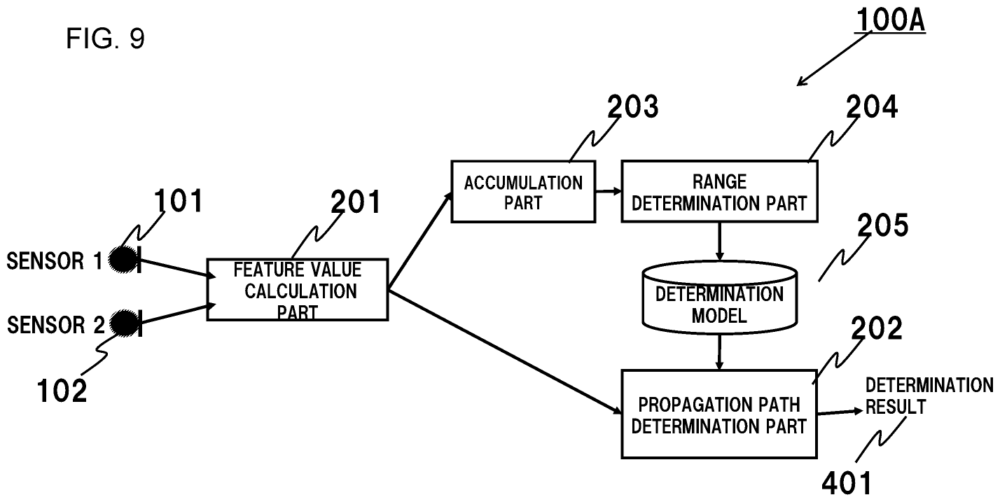

Next, a detail of a second exemplary embodiment that enables improving accurate determination will be described, with reference to the drawings. FIG. 9 is a block diagram showing a configuration of the second exemplary embodiment of the present invention. A propagation path estimation apparatus 100A of the second exemplary embodiment of this invention also comprises accumulation part 203, range determination part 204 and determination model 205, other than configuration of the first exemplary embodiment. Hereafter, differences between the first exemplary embodiment and the second exemplary embodiment will be described focusing on the differences, since other configuration is similar to the first exemplary embodiment.

Accumulation part 203 accumulates feature value that feature value calculation part 201 calculated in the past for a certain period of time. Feature value accumulating period in the accumulation part 203 may be long such as ones since the installation of a plurality of sensors 101, 102, but typically may be for one day in the past for instance. Hereafter, in this exemplary embodiment, accumulation part 203 accumulates 86400 frames for one day without duplication provided that a duration of one frame is one second.

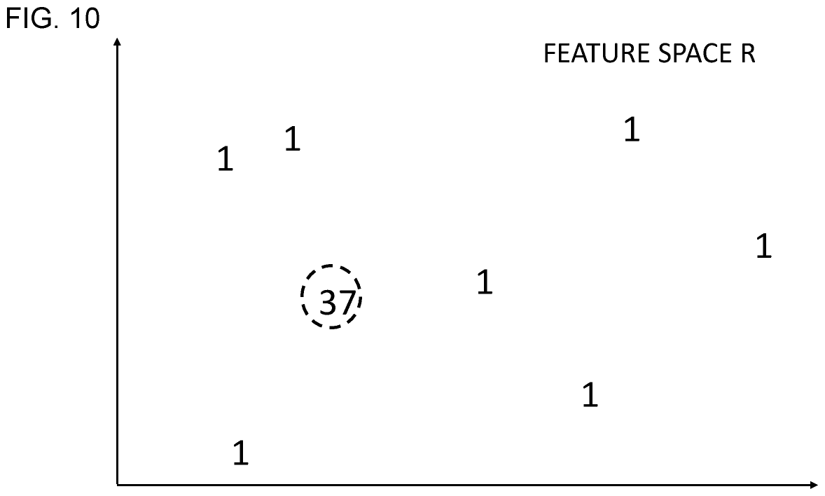

The range determination part 204 maps feature value for all the frames accumulated by the accumulation part 203 to a feature space. FIG. 10 shows an example of feature value mapping by the range determination part 204. An example in FIG. 10 shows only for 44 frames, but it is similar when the number of accumulated frames is varied.

FIG. 10 is a two-dimensional histogram with two correlation functions as variables (also called “heat map”), each number in FIG. 10 represents a number of frames expressed by value, which corresponds to a certain feature value. In the example shown in FIG. 10, 37 frames have almost the same feature value and the other frames are of different feature value each other. Here, the fact that a large number of frames have the same feature value means that the variance of the feature value is small and consists of only delay term, so the range shown in FIG. 10 as dashed circle can be determined as a range of propagation path in solid substance. On the other hand, the rest of the range means that the variance of the feature value is large, so the rest of the range can be determined as a range of propagation path is in-air. As the condition for being a large number of frames here, a condition under which all the points are taken that exceed a predetermined threshold value D, a condition can be adopted. Of course, instead of the condition that the threshold D is exceeded, it can be a feature value that assumes the maximum value ε, the radius of the range circle can be predetermined to a small value, assuming the range affected by the noises.

Determination model 205 is a range of information acquired as described above and stored as a determination model. Therefore, said range determination part 204 can be called as determination model creation part.

Accumulation part 203 described above can be configured by using a storage device of a computer that configures the propagation path estimation apparatus. Similarly, determination model 205 can be stored in the storage device of the computer that configures the propagation path estimation apparatus.

A propagation path determination part 202 compares the value of feature value that is output from the feature value calculation part 201, and the range of information that is stored in said determination model 205, determines whether the feature value concerned is in-air or in solid substance, and outputs the determination result as a determination output 401.

Next, an effect of this exemplary embodiment will be described. Since a determination can be done using the past information in this exemplary embodiment, a most suitable determination according to an installed environment and improvement in the accuracy can be realized. In the above described exemplary embodiment, description is made on the case where feature value is accumulated for past one day and determination model 205 is created, but the accumulated feature values can be layered according to various viewpoints and create one or more determination models. For example, in case of an installation environment in which propagation path estimation apparatus is placed varies according to the time-point or season, the apparatus can create determination models according to the feature values obtained in a time range that includes the time-point or in the season concerned, and determine according to the result and determination model.

Also, by installing the propagation path estimation apparatus of the present invention, a recording apparatus of the present invention can be realized that is easy to be listened and performs an appropriate process according to propagation path. Also in acoustic event detection apparatus having a high detection performance can be configured by installing the propagation path estimation apparatus of the present invention.

Although the respective exemplary embodiments of the present invention have been described above, the present invention is not limited to the above-described exemplary embodiments, and further modifications, replacements, and adjustments can be made without departing from the basic technical concept of the present invention. For example, the network configuration, the configuration of each element, and the expression form of the message shown in each drawing are examples for helping understanding of the present invention, and are not limited to the configurations shown in these drawings. Further, in the following description, “A and/or B” is used to mean at least one of A and B [that is, A or B, or (A+B)].

In addition, the procedure shown in the above-described first and second exemplary embodiments can be realized as a program for causing a computer (9000 in FIG. 16) that functions as the propagation path estimation apparatus 100 to execute processings as the propagation path estimation apparatus. For example, this kind of computer has a configuration comprising Central Processing Unit (CPU) 9010, Communication I/F 9020, Memory 9030, and Auxiliary Storage Device 9040 as described in FIG. 16. That is, the CPU 9010 of FIG. 16 executes the data transmission/reception program and the data conversion program, and refers to the propagation path estimation apparatus information held in the auxiliary storage device 9040 to execute the processing of the received data and the data transmission processing.

That is, each part (processing means, function) of the propagation path estimation apparatus shown in the above-described first and second exemplary embodiments can be realized by a computer program that causes the processor to perform the above-described processing by using the hardware of the processor mounted in the computer.

Finally, preferable modes of the present invention will be summarized.

### [Mode 1]

(Refer to above propagation path estimation apparatus of the first aspect of the present invention.)

### [Mode 2]

In the propagation path estimation apparatus described above, it may be determined whether the propagation path is in air or in a solid substance by utilizing a fact that the in-air propagation path has multiple reflections and a cross-wall propagation path propagates only direct sound.

### [Mode 3]

In the propagation path estimation apparatus described above, it may be determined that the propagation path is in the solid substance by utilizing a difference in the propagation path being caused by only a delay related term.

### [Mode 4]

In the propagation path estimation apparatus described above, the difference in the propagation path is accumulated, a range to identify whether the propagation is in air or in the solid substance is determined, and it is determined based on the range whether the propagation path is in air or in the solid substance.

### [Mode 5]

The propagation path estimation apparatus described above also comprises an accumulation part that accumulates the feature value calculated by the feature value calculation part, and a range determination part that creates a determination model that determines a range of the propagation path extending in the solid substance; wherein the propagation path determination part determines the propagation path based on the feature value calculated by the feature value calculation part and the determination model.

### [Mode 6]

In the propagation path estimation apparatus described above, as the plurality of sensors, the apparatus is provided with two or more of the same type selected from the group consisting of microphone, supersonic microphone, and infrasonic sensor.

### [Mode 7]

(Refer to propagation path estimation method according to the second aspect of this invention.)

### [Mode 8]

(Refer to program according to the third aspect of the invention)

Mode 7 and Mode 8 can be expanded to Modes 2 to 6 likewise as the Mode 1.

It is to be noted that each of the disclosures in the abovementioned patent literatures and non-patent literatures is incorporated herein by reference. Modifications and adjustments of embodiments and examples are possible within the bounds of the entire disclosure (including the claims) of the present invention, and also based on fundamental technological concepts thereof. Furthermore, a wide variety of combinations and selections of various disclosed elements is possible within the scope of the claims of the present invention. That is, the present invention clearly includes every type of transformation and modification that a person skilled in the art can realize according to the entire disclosure including the claims and to technological concepts thereof. In particular, with respect to the numerical ranges described in the present application, any numerical values or small ranges included in the ranges should be interpreted as being specifically described even if not otherwise explicitly recited.

### SIGNS LIST

100A, 100B Propagation path estimation apparatus
101, 102 Sensor
201 Feature value calculation part
202 Propagation path determination part
203 Accumulation part
204 Range determination part
205 Determination model
300 Acoustic source
301 Wall
401 Determination result
9000 Computer
9010 CPU
9020 Communication I/F
9030 Memory
9040 Auxiliary storage device

What is claimed is:

1. A propagation path estimation apparatus, comprising:
a memory configured to store instructions, and
a processor configured to execute the instructions,
the instructions comprising:
calculating feature value from output signals from a plurality of sensors, and
determining a propagation path corresponding to the feature value.

2. The propagation path estimation apparatus according to claim 1, wherein it is determined whether the propagation path is in air or in a solid substance by utilizing a fact that the in-air propagation path has multiple reflections and a cross-wall propagation path propagates only direct sound.

3. The propagation path estimation apparatus according to claim 2, wherein it is determined that the propagation path is in the solid substance by utilizing a difference in the propagation path being caused by only a delay related term.

4. The propagation path estimation apparatus according to claim 2, wherein the difference in the propagation path is accumulated, a range to identify whether the propagation is in air or in the solid substance is determined, and it is determined based on the range whether the propagation path is in air or in the solid substance.

5. The propagation path estimation apparatus according to claim 1, wherein the instructions further comprises:
accumulating the feature value calculated by the feature value calculating, and
creating a determination model that determines a range of the propagation path extending in the solid substance; wherein
the propagation path is determined based on the feature value calculated by the feature value calculating and the determination model.

6. The propagation path estimation apparatus according to claim 1, wherein as the plurality of sensors, the apparatus is provided with two or more of the same type selected from the group consisting of microphone, supersonic microphone, and infrasonic sensor.

7. A propagation path estimation method, comprising:
calculating feature value from output signals of a plurality of sensors, and
determining a propagation path corresponding to the feature value.

8. The propagation path estimation method according to claim 7, wherein it is determined whether the propagation path is in air or in a solid substance by utilizing a fact that the in-air propagation path has multiple reflections and a cross-wall propagation path propagates only direct sound.

9. The propagation path estimation method according to claim 7, wherein the difference in the propagation path is accumulated, a range to identify whether the propagation is in air or in the solid substance is determined, and it is determined based on the range whether the propagation path is in air or in the solid substance.

10. A computer-readable recording medium storing a program for causing a computer to perform:
a process of calculating feature value from output signals of a plurality of sensors, and
a process of determining a propagation path corresponding to the feature value.

11. The propagation path estimation method according to claim 8, wherein the difference in the propagation path is accumulated, a range to identify whether the propagation is in air or in the solid substance is determined, and it is determined based on the range whether the propagation path is in air or in the solid substance.

12. The propagation path estimation method according to claim 7, further comprising:
accumulating the feature value calculated by the feature value calculating, and
creating a determination model that determines a range of the propagation path extending in the solid substance; wherein
the propagation path is determined based on the feature value calculated by the feature value calculating and the determination model.

13. The propagation path estimation method according to claim 7, wherein the output signals of the plurality of sensors comprise output signals of the sensors of two or more of the same type selected from the group consisting of microphone, supersonic microphone, and infrasonic sensor.

14. The medium according to claim 10, wherein in the program, it is determined whether the propagation path is in air or in a solid substance by utilizing a fact that the in-air propagation path has multiple reflections and a cross-wall propagation path propagates only direct sound.

15. The medium according to claim 14, wherein it is determined that the propagation path is in the solid substance by utilizing a difference in the propagation path being caused by only a delay related term.

16. The medium according to claim 14, wherein the difference in the propagation path is accumulated, a range to identify whether the propagation is in air or in the solid substance is determined, and it is determined based on the range whether the propagation path is in air or in the solid substance.

17. The medium according to claim 10, wherein the program further comprises:
accumulating the feature value calculated by the feature value calculating, and
creating a determination model that determines a range of the propagation path extending in the solid substance; wherein
the propagation path is determined based on the feature value calculated by the feature value calculating and the determination model.

18. The medium according to claim 14, wherein the output signals of the plurality of sensors comprise output signals of the sensors of two or more of the same type selected from the group consisting of microphone, supersonic microphone, and infrasonic sensor.
